(19) United States
(12) Patent Application Publication
(10) Pub. No.: US 2026/0365152 A1
(43) Pub. Date: Nov. 19, 2026

(54) METHOD FOR OPERATING AN ELECTROMECHANICAL BRAKING DEVICE, AND ELECTROMECHANICAL BRAKING DEVICE FOR A MOTOR VEHICLE

(71) Applicants: thyssenkrupp Presta AG, Eschen (LI); thyssenkrupp AG, Essen (DE)

(72) Inventors: Zoltan Szabolcs ERDELYI, Budapest (HU); Barna SZIMANDL, Gams (CH); Mark MULLER, Budapest (HU)

(73) Assignees: thyssenkrupp Presta AG, Eschen (LI); thyssenkrupp AG, Essen (DE)

(21) Appl. No.: 19/136,682

(22) PCT Filed: Oct. 24, 2023
(86) PCT No.: PCT/EP2023/079666

§ 371 Date: Jun. 6, 2025

(30) Foreign Application Priority Data
Dec. 8, 2022 (BE) BE 2022/5999
Apr. 14, 2023 (BE) BE 2023/5281

(51) Int. Cl. B60T 17/22; B60T 13/74; F16D 55/226; F16D 65/18; F16D 121/24; F16D 125/40

(52) U.S. Cl. CPC B60T 17/221; B60T 13/746; F16D 65/18; B60T 2270/402; F16D 55/226; F16D 2121/24; F16D 2125/40

(57) ABSTRACT

A method for operating an electromechanical braking device containing a brake part, a counter brake part, and an electromotive actuator, comprises, in order to produce application of the brake, moving the brake part by means of the actuator in an adjustment direction from a release position, in which an air gap is arranged between the brake part and the counter brake part, into braking contact with the counter brake part, while overcoming the air gap. Prior to producing application of the brake, the brake part is positioned by the actuator in an initial position in which a defined air gap width of the air gap between brake part and counter brake part is specified.

### PRIOR ART

The invention relates to a method for operating an electromechanical braking device, containing a brake part, a counter brake part and an electromotive actuator, in which to produce application of the brake the brake part is moved by means of the actuator in an adjustment direction from a release position in which an air gap is arranged between the brake part and the counter brake part into braking contact with the counter brake part while overcoming the air gap. An electromechanical braking device is also the subject of the invention.

Such a braking device of a motor vehicle is in the form of a friction brake, in which a brake part supported on the chassis and fixed relative to the rotation of the wheel to be braked can be brought into braking application by means of an actuator with a counter brake part which rotates with the wheel. When in braking application, a frictional contact is produced between the brake part and the counter brake part, the so-called brake contact, wherein the braking torque produced by friction increases as the adjustment force exerted by the actuator in the adjustment direction increases.

A common design are disc brakes, which are known in principle, in which the counter brake part is formed by a brake disc rotating with the wheel and which is axially encompassed on both sides by a brake caliper. By means of at least one preferably linear actuator drive axially supported on the caliper, a brake part, usually a brake pad, can be adjusted in an axial adjustment direction and thus brought into frictional contact with an axial side of the brake disc, wherein the brake disc is frictionally clamped between the adjusted brake part and another brake part axially supported on the brake caliper when the brake is applied.

The prerequisite for proper function and precise response of the brake is that a distance, the so-called air gap, is provided in the adjustment direction between the brake part and the counter brake part when the brake is not applied. When the brake is applied, the brake part is moved by the actuator perpendicular to the air gap towards the counter brake part until the air gap is overcome and the frictional brake contact is reached, so that application of the brake is produced.

For a reproducible response of the brake during driving, it is crucial that the air gap in the axial adjustment direction has as constant an air gap width as possible in the not applied state. This air gap width can increase in operation, for example due to wear of the brake pad and/or the brake disc, and must be readjusted accordingly. It is known from DE 10 2017 123 266 A1 that the actuator includes at least one actuator drive that can be driven by an electric actuator, for example a spindle drive or the like. Through this, the brake part can be advanced in the adjustment direction towards the counter brake part in order to reduce the width of the air gap and to produce application of the brake, or, conversely, it can be set back away from the counter brake part in order to increase the width of the air gap and release the brake. Although the air gap width can be changed by the actuator, it does not result in a more reproducible response when driving. This can also lead to noise generation during driving that is perceived as annoying.

In view of the problem explained above, it is one of the objects of the present invention to enable improved operation in the case of an electromotive braking device.

### Presentation of the Invention

According to the invention, this object is achieved by the method with the features of claim 1 and the braking device as claimed in claim 11. Advantageous developments arise from the dependent claims.

With a method for the operation of an electromechanical braking device, containing a brake part, a counter brake part and an electromotive actuator, in which, in order to produce application of the brake, the brake part is moved by means of the actuator in an adjustment direction from a release position, in which there is an air gap between the brake part and a counter brake part, while overcoming the air gap, into braking contact with the counter brake part, it is provided according to the invention that before application of the brake is produced, the brake part is positioned by the actuator in an initial position in which a defined air gap width of the air gap between the brake part and the counter brake part is specified.

In accordance with the method according to the invention, the braking device is initialized by means of the actuator, wherein the brake part is positioned relative to the counter brake part in a defined manner. This is achieved by adjusting the brake part to the initial position. The defined air gap width that is preset to a predefined value corresponds to the distance in the adjustment direction between the corresponding friction surfaces of the brake part and the counter brake part, which are facing towards each other in the axial direction. As a result, the adjustment distance between the initial position and the brake contact required for a braking process that must be overcome by operating the actuator can be kept constant while driving. Changes in the width of the air gap occurring during operation, for example due to abrasion, wear, temperature fluctuations and the like, can be compensated for by the method according to the invention during operation of the vehicle, so that a consistent, reproducible response of the brake can be realized in an advantageous way.

In the prior art, the air gap is usually adjusted during the installation or maintenance of the braking device, wherein changes in the air gap width that occur during driving due to continuous wear and tear cannot be satisfactorily compensated for despite the relatively high effort. In contrast, the invention has the advantage that the electromotive actuator can be used to achieve optimum functional reliability in the operation of the vehicle without external maintenance or adjustment effort, and a consistently high level of operating comfort can be achieved solely through the actuator integrated in the brake.

The initialization according to the invention of the braking device can be carried out by controlling the actuator, for example automatically by the electronic control systems available in the vehicle. For example, it is possible to routinely adjust the brake part to the initial position when the vehicle is started, so that not only wear but also potential influences caused by changing environmental conditions, such as extreme temperature changes or the like, can be compensated. Alternatively or additionally, the initial position can be set after a or each braking process, so that optimal operating conditions can be guaranteed for a subsequent braking operation.

The defined air gap width, which can also be referred to as the initial width, is greater than zero. There is no air gap during brake contact, which can also be referred to as an application position or brake application, i.e. the air gap width is zero. The defined air gap width is preferably smaller than a maximum air gap width, which can be specified by the actuator between the brake part and the counter brake part.

The initial position set according to the invention by the actuator forms a starting position or initial position of the braking stroke or the working stroke also produced by the actuator, by which the brake part is adjusted in the adjustment direction during a braking operation up to the frictional brake contact with the counter brake part. Accordingly, the brake part is preferably held at rest in the initial position at least temporarily or is releasably fixed before a subsequent braking process is initiated. It is then moved from the initial position to brake contact by the brake stroke. Accordingly, the advantage is realized that the brake stroke must correspond consistently to the defined air gap width during each braking operation. This results in the significant advantage that the response remains constant regardless of wear.

A further advantage is that the adjustment characteristics of the actuator can be optimally adapted to the constant adjustment distance for each braking process according to the invention. For example, it is possible to specify an optimized force-displacement characteristic adapted to the air gap width. For example, starting in the initial position, the brake part can first be moved quickly with low force, and a higher force can be applied when or shortly before the brake contact is reached, optionally with a lower adjustment speed. This can be carried out, for example, by corresponding electrical control of a servomotor. Alternatively or additionally, a non-linear mechanical adjustment kinematics of the actuator may be provided, for example by means of known wedge disc, ball ramp or tilt pin arrangements or the like. This allows the response to be optimized and unwanted noise generation to be avoided.

Another advantage is that the specification of the defined air gap width allows the brake characteristics and the response of the brake to be adapted without additional installation or adjustment effort. For example, a targeted reduction of the defined air gap width can achieve a faster and more sensitive response of the brake, for example for a sporty driving style.

An advantageous execution of the method may include performing a calibration routine to set the defined air gap width, including the following steps:
Adjustment of the brake part to a reference position;
Adjust the brake part from the reference position to the initial position.

It is preferable that the reference position is formed by the brake contact.

The calibration routine is a calibration method for determining the defined air gap width by means of the adjustment drive. The reference position is a position that is clearly correlated with the brake contact, for example the position of the brake contact in the adjustment direction itself. A possible reference position has a fixed specified distance to the brake contact and is therefore referred to synonymously below as the brake contact.

In the first step, the brake part is adjusted by the actuator towards the counter brake part, forwards by definition, until it contacts the counter brake part at brake contact. This adjustment can also be referred to as advancing, corresponding to the forwards adjustment direction. The reference position in brake contact can preferably be set as the zero position. From the brake contact, the brake part is adjusted away from the counter brake part, in the reverse adjustment direction, being adjusted back to the initial position by an adjustment distance corresponding to the defined air gap width. This adjustment can also be referred to as resetting according to the rearward adjustment direction. This makes it possible to achieve exact positioning of the brake part in the initial position with little effort by simply specifying the adjustment distance, regardless of a possible shift in the absolute position of the brake contact due to wear or the like.

A calibration routine can be carried out when starting the vehicle before starting the journey, preferably automatically. It is alternatively or additionally conceivable and possible to carry out the calibration after one or every braking operation, based on the brake contact that inevitably occurs during this process.

To implement the aforementioned procedure, it is possible with little effort to record a reference position when in brake contact and then control the actuator in order to adjust the brake part from the reference position to the initial position by a specified adjustment distance. In brake contact, for example, a current zero position can be recorded and stored electronically. Based on this, the actuator can be controlled to adjust by the magnitude of the defined air gap width in order to set the initial position.

It is advantageous that the current position of the brake part is detected, preferably by a sensor device. Preferably, the brake contact can be detected by an electrical sensor device, set as a zero position and stored in an electrical control device. The sensor device can be preferably arranged on the actuator or formed together with it. For example, a force sensor that registers the brake part stopping at the counter brake part at brake contact. With particularly little effort, stopping at brake contact can be detected by a current increase produced by the electric servomotor. Alternatively or additionally, measuring devices may also be provided that are designed to measure absolute position values or the relative position value of the brake part relative to the counter brake part, for example by means of well-known distance or position measurement methods.

In an advantageous design, the sensor device can be in the form of a rotor position sensor of the actuator motor. Actuator motors, for example in the form of a synchronous machine, are often already equipped with a rotor position sensor. Due to the previously known mechanical ratio between the rotation angle of the rotor shaft and the stroke of the thrust piece, the absolute position value can be determined by determining the rotation angle of the rotor shaft.

Preferably, the rotor position sensor can be in the form of an inductive, magnetic or optical sensor.

It is possible that the actuator is position-controlled. For example, a position sensor may be provided that indicates absolute position values or a relative position value of the brake part relative to the counter brake part. From the detected zero position at brake contact, a value for the initial position with the defined specified air gap width can be determined, which is used to control the actuator.

It can be advantageous that the actuator is distance-controlled. This makes it possible to adjust the actuator to the initial position by an adjustment distance specified by the control system with little effort. Such distance control can be implemented with little effort, for example, by an electric motor control system, which controls the servomotor with a signal sequence that generates an adjustment by a defined specified adjustment distance.

An advantageous implementation is made possible by the fact that the actuator has an actuator drive and a spindle drive that can be driven rotationally by a servomotor. The spindle drive forms a continuously operating linear drive for the brake part, which has, in a well-known way, a threaded spindle engaging in a spindle nut which can be driven rotationally relative to the threaded spindle by the actuator motor. The adjustment distance is directly correlated with the amount of rotation of the rotor shaft of the servomotor and the pitch of the threaded spindle. Accordingly, a defined angle of rotation of the rotor shaft can be specified by controlling the servomotor with a control signal, which causes a linear adjustment of the brake part by a defined adjustment distance. For example, at brake contact the servomotor can be controlled with a defined electrical control signal in order to move the brake part to the initial position with distance control. One advantage of this is that the method according to the invention can be realized solely by the electrical control of the servomotor, including the detection of brake contact by evaluation of the motor current and the positionally accurate adjustment of the initial position.

If required, additional position, displacement, force or other sensors can be provided, for example to detect brake contact or to monitor the defined air gap width redundantly.

It may be preferable that the actuator has a first actuator drive and a second actuator drive coupled to it in series. In each case, an actuator drive forms an axially effective lifting or adjustment device in the adjustment direction. For example, an actuator drive can have a spindle drive.

Other designs of actuator drives can also be used, which may include, for example, ramp bearings, cam plates or cam discs, tilt pin assemblies or the like, and also convert a rotation of the drive element into a linear adjustment of the output element. Because the two actuator drives are arranged in series in the adjustment direction, i.e. are arranged one behind the other, the brake element can be linearly adjusted together with the second actuator drive by actuating the first actuator drive to produce application of the brake. By adjusting the second actuator drive independently of the actuation of the first actuator drive, the air gap defined according to the invention can be adjusted. The first actuator drive can thus be operated continuously in the optimal working range.

In the aforementioned design, it is advantageous that application of the brake is produced by a first actuator drive, which can thus be described as a brake drive or working drive, and that the initial position is set by the second actuator drive by means of an actuator drive which can accordingly be described as an adjustment drive. During operation, when the brake is applied, the brake drive preferably performs a constant brake stroke with each braking operation, which moves the brake part forwards to application of the brake. With the adjustment drive, which preferably has a spindle drive, the brake part can be adjusted to the initial position. The fact that the defined air gap width is adapted to the fixed, constant braking stroke of the brake drive means that it can be operated continuously at the optimum operating point.

In the case of an adjustment device with two serially arranged actuator drives, in which the first actuator drive, the brake drive, performs a constant brake stroke and the second actuator drive, the adjustment drive, is adjustable for adjusting the air gap, the method according to the invention may include the following steps:
resetting the adjustment drive,
moving the brake drive forwards,
moving the alignment drive forwards to brake contact,
resetting the brake drive.

Moving the brake drives forwards refers to an adjustment in the adjustment direction towards the counter brake part, by definition forwards. Accordingly, resetting refers an adjustment in the opposite adjustment direction away from the counter brake part, by definition backwards, i.e. rearwards.

After performing the aforementioned steps, the brake part is positioned in the initial position.

This realizes the advantage that in a subsequent braking process, in which the brake part is moved forwards with the constant brake stroke towards the counter brake part, it is adjusted to optimal application of the brake.

In the case of an electromechanical braking device for a motor vehicle, containing an actuator and a brake part connected to it, which can be adjusted by the actuator in an adjustment direction and can be brought to braking application with a counter brake part, and containing a control device for controlling the actuator, it is provided according to the invention that the actuator is controllable by the control device for the purpose of setting an initial position in which a defined air gap width of the air gap between the brake part and the counter brake part is specified.

The features mentioned above in connection with the method according to the invention may be realized individually and in combinations in the braking device according to the invention.

The adjustment direction preferably extends along an axis, for example the axis of a spindle drive of an actuator drive.

It is advantageous that the control device is connected to at least one sensor device that is designed to detect the position of the actuator and/or to detect the adjustment distance of the actuator. An advantageous design is that the control device is connected to at least one sensor device that is designed to detect a brake contact between the brake part and the counter brake part. As explained above in connection with the method according to the invention, it is advantageous, for example, to detect the brake contact as a zero position, for example by monitoring the motor current of a servomotor, or by another measurement method. The measured values recorded in this way can be stored and processed in the control unit in order to control the actuator motor(s) of the adjustment device on the basis thereof.

It is preferable that the control device is designed to adjust the actuator to a predetermined position and/or to adjust the actuator by a predetermined adjustment distance. This allows the initial position to be set based on the brake contact, for example.

It may preferably be provided that the control device has a control input for entering an initial value, and the control device is designed for setting the actuator device to an initial position corresponding to the initial value entered. This allows the initial position to be adjusted to achieve a desired brake characteristic. For example, the defined air gap width can be reduced for a faster response of the brake and/or a greater braking effect.

Preferably, the adjustment drive for adjusting the air gap width, which can also be referred to as an adjusting drive, can have a spindle drive. The other adjustment drive, which can also be referred to as a brake drive or working drive, can have, for example, ramp bearings, cam plates or cam discs, tilt pin arrangements or the like. These are preferably designed in such a way that they perform a constant brake stroke every time the brakes are applied, i.e. a constant adjustment distance in the adjustment direction.

It may be provided that the braking device contains an actuator and a brake part connected to it, which can be adjusted by the actuator along an axis, i.e. in an adjustment direction and can be brought into application of the brake with a counter brake part, wherein the actuator has a first actuator drive and a second actuator drive coupled to it in series, wherein the first actuator drive has a rotationally drivable first drive wheel, and the second actuator has a rotationally drivable second drive wheel coaxial to the first drive wheel, wherein a coupling device is arranged between the first drive wheel and the second drive wheel. It may be provided that the coupling device is in the form of a friction coupling with a friction element that can be frictionally connected to a counter friction element when the coupling is engaged.

In the following, the first and second drive wheels are also referred to together as the two drive wheels or the drive wheels for short.

The drive wheels can be in the form of a gear wheel, for example a spur gear, or of a belt wheel or toothed belt wheel or worm gear, so that a gear wheel is generally provided by means of which a drive torque can be coupled from an electric servomotor into the actuator drive.

A friction coupling can be implemented between the drive wheels. This contains a friction element that is torque locked to one of the drive wheels and a corresponding counter friction element that is torque locked to the other drive wheel. The friction element can be brought into frictional coupling engagement with the counter friction element in any relative angular position. A purely force-fit coupling is realized here, in contrast to the form-fitting snap-in connection in the prior art. This allows the position of the drive wheels relative to each other to be continuously predetermined, in contrast to the discrete detent stages in the prior art. Accordingly, a uniform, continuous adjustment of the second actuator drive relative to the first actuator drive is possible, and a continuous adjustment of the air gap can be carried out. This is particularly advantageous with regard to uniform tracking of the optimum operating point of the braking device to the continuous wear of the brake part during operation, i.e. the continuous wear of the brake pad. Compared to the only step-by-step adjustment option of the prior art, a consistently improved response of the braking device can be realized, and thus increased operational reliability and greater ease of use.

An advantage over a latching coupling described in the prior art is that in order to operate and release the coupling device, essentially no axial relative movement is required between the coupling elements when the coupling is engaged, for example between the drive wheels or the latching elements, which must necessarily be movable relative to each other in order to produce and release the latching form fit. On the other hand, the pure force fit between the friction and counter friction elements according to the invention can simply be specified by the applied axial actuating force, wherein the friction and counter friction elements do not have to be moved axially relative to each other. This allows for a simpler and more reliable design of the coupling device.

It is preferable that the friction coupling has a defined predetermined coupling torque. The coupling torque indicates the maximum differential torque, which can be transmitted between the friction element and the counter friction element by means of frictional adhesion in the coupling engagement. When the coupling torque is exceeded, the coupling device slips, causing the two drive wheels to rotate relative to each other. One advantage of this is that the friction coupling according to the invention slips continuously and smoothly, so that an improved, uniform readjustment of the air gap is possible. In addition, no axial deflection movements of latching elements have to be taken into account and absorbed by design as with the well-known snap on coupling.

It is advantageous that the friction element and the counter friction element are arranged coaxially. The coaxial arrangement corresponds to the coaxial arrangement of the drive wheels. The friction element and the counter friction element can be arranged in a simple design and in a compact construction in the area of the axially opposite faces of the drive wheels. Due to the generation described above of the pure frictional connection of the coupling, no moving parts are required as with the snap on coupling in the prior art.

In an advantageous design, it may be provided that the friction element and the counter friction element are conical. The friction element may have a conical cone section converging at least in sections in the axial adjustment direction with a conical friction surface, which may be in the form of an outer cone or an inner cone, and which is designed with a corresponding cone section on the counter friction element, which is formed in the opposite sense as an inner cone or outer cone and has a conical counter friction surface. To produce the coupling engagement, the outer cone is inserted in the inner cone, wherein the conical friction and counter friction surfaces are frictionally loaded against each other by an axial operating force of the coupling. One advantage of this is that the cone allows a force transfer of the axially acting operating force of the coupling into the normal force acting between the conical friction surfaces in the friction contact. For example, a relatively small axial actuation force can be converted into a greater normal force in the friction contact by means of a shallower incline, wherein a high coupling torque can be achieved even with a relatively small axial actuating force of the coupling.

As an alternative or in addition to the aforementioned design, it may be provided that the friction element and the counter friction element are planar. The corresponding friction surfaces are formed, at least in sections, as flat axial surfaces, similar to a disc coupling. A space-saving arrangement is made possible, especially if only a relatively small coupling torque is to be realized.

It may be preferable that the friction element and the counter friction element are pre-loaded against each other. Preferably, the friction element and the counter friction element are elastically pre-loaded or spring pre-loaded against each other. The friction and counter friction surfaces are pressed against each other with a predetermined axial preload force in frictional engagement. To generate the preload force, an elastic preloading element may preferably be provided, for example a spring element or the like. The coupling torque of the friction coupling is determined by the actuating force acting perpendicular to the friction contact, i.e. the axially applied force between the friction and counter friction element, wherein the greater the preload force, the greater the coupling torque. This opens up the advantageous possibility of simply specifying the coupling torque by the preloading force exerted by the preloading element. For example, in the case of a spring element that is pressure-elastic in the axial direction, such as a compression spring, the preload force exerted can simply be specified and adjusted by the spring constant and the compression of the spring.

The aforementioned embodiment can be implemented in an advantageous way by the fact that the friction element and/or the counter friction element can be axially displaced and supported against the first drive wheel or the second drive wheel by an axially effective spring element.

The friction element or the counter friction element is connected by torque locking and axially displaceably to one of the drive wheels, for example via radially protruding drivers that produce a form fit effective in the circumferential direction. The spring element axially clamped between the friction element or the counter friction element and one of the drive wheels, which is preferably in the form of an axially effective compression spring, ensures that the friction or counter friction element is axially pre-loaded against the corresponding counter friction or friction element axially supported on the other drive wheel, i.e. is axially pressed against it in frictional contact.

The corresponding counter friction or friction element is connected to the other drive wheel in a rotational fit. It is also possible that alternatively or additionally the counter friction element is supported by a spring element on one of the drive wheels. An advantage of this arrangement is that the friction coupling according to the invention can be integrated between the drive wheels in a simple and space-saving manner.

In an advantageous development, it is possible for the friction element and/or the counter friction element to be arranged in the first drive wheel or the second drive wheel. For example, it is possible that one drive wheel is designed essentially drum-shaped, so that the friction or counter friction element can be arranged in an interior enclosed by the circumferential gear wheel or gear ring. This enables a compact design that is protected against external influences. For example, the drive wheel of the first actuator drive may have a conical friction element which engages axially in a counter friction element in the form of an inner cone, which is at least partially arranged within the second drive wheel.

A particularly compact design can be achieved-especially with the latter version-due to the fact that the drive wheels are arranged within the axial extent of the actuator drives, i.e. they are not mounted axially protruding on one side.

It is preferable that the friction element and/or the counter friction element have a friction facing. The friction element and counter friction element preferably have a metallic base body, for example made of steel. To avoid metal-to-metal contact, a coating or facing can preferably be applied to create a friction pair with a defined friction force, for example of sintered, metal and/or ceramic friction materials, composite materials or the like. This ensures a defined, reproducible coupling torque.

It may be provided that an actuator drive has a spindle drive. In this case, a threaded spindle engages in a spindle nut in a well-known way, and a relatively rotating drive via a drive wheel connected to the threaded spindle or the spindle nut. It is possible that the spindle nut forms the drive-side drive element of the actuator drive, and the threaded spindle forms the output element on the output side linearly adjustable relative thereto, or vice versa.

It is possible for an actuator to have a ball ramp arrangement, a wedge disc arrangement, or a tilt pin assembly. In a ball ramp arrangement, also known as a ramp bearing, the drive element and output element preferably have cam plates with tracks or ramps inclined relative to the axis, between which circumferentially rollable balls are arranged. A relative rotation leads to the output element being axially displaced relative to the drive element due to the ball rolling on the ramps. In a well-known tilt pin arrangement, tilt pins are arranged between the drive element and output element and are each supported in the circumferential direction in such a way that they are tilted more or less relative to the axis during a relative rotation, depending on the direction of rotation, wherein the distance between the drive element and the output element can also be adjusted.

In the actuator, two equally acting actuator drives can be combined as first and second actuator drives, for example two spindle drives. It is also possible to combine two different designs, for example a ball ramp arrangement as the first actuator drive, and a spindle drive as a second actuator drive for adjusting the air gap. Here the respective characteristic properties of each design can be optimally exploited. For example, a ball ramp arrangement can be used to achieve a nonlinear adjustment characteristic with little effort, and/or at least self-locking properties in sections, and/or a defined dead center or stretched position that enables a defined adjustment distance. The realization of the mentioned positive properties may at least partially require a precise specification of the air gap, which is not possible with the latching coupling in the prior art, but can be easily realized by means of the friction coupling according to the invention.

With a method for the operation of an electromechanical braking device having an actuator containing a first actuator drive and a serially coupled actuator drive, and which acts on a brake part which can be brought along an axial direction into braking application with a counter brake part, wherein the first actuator drive has a rotationally drivable first drive wheel to which a first drive torque can be applied for actuation, and the second actuator drive has a rotationally drivable second drive wheel coaxial to the first drive wheel, to which a second drive torque can be applied for actuation, wherein a coupling device is arranged between the first drive wheel and the second drive wheel, it may be provided that the coupling device is in the form of a friction coupling and has a predetermined coupling torque, wherein when the predetermined coupling torque is exceeded the first drive wheel slips smoothly relative to the second drive wheel, wherein to actuate the first actuator drive, the first drive wheel and the second drive wheel are driven synchronously, so that the second actuator drive remains unactuated, and to actuate the second actuator drive the second drive wheel is driven, and the first drive wheel is stopped relative to it, so that the friction coupling slips and the first actuator drive remains unactuated.

The features mentioned above in connection with the braking device can be used individually and in combination to implement the method.

To adjust the first actuator drive, an actuating torque can be coupled into the first drive wheel by means of a first electric servomotor, and accordingly the second actuator drive can be driven by a second servomotor.

In the normal braking mode, the first and second drive wheels rotate synchronously. On the one hand, this can be done by driving the first and second drive wheels by the first and second servomotors with synchronized drive torques. On the other hand, when the first drive wheel is driven, the second drive wheel can be carried along synchronously by the coupling device, as long as the transmitted drive torque remains below the coupling torque. In this operating mode, the second actuator drive remains unactuated, and rotates freely as a whole together with the brake element.

The coupling device can slip continuously and evenly when the coupling torque is exceeded to adjust the air gap, in contrast to the prior art. This can be achieved, for example, by fixing the drive wheel of the first actuator drive, for example by a brake or by appropriate control of the first drive motor, while the second drive motor applies a second drive torque to the second drive wheel that is greater than the coupling torque. As a result, the second drive wheel is rotated relative to the first drive wheel, and by actuating the second actuator drive, the air gap can be adjusted continuously and sensitively, so that continuously progressive wear of the brake element or brake pad can be optimally compensated.

It is possible that the first drive wheel and the second drive wheel are coupled in a torque locked manner by the friction coupling to produce a synchronous drive. Here there is no need for a synchronous drive of the two drive wheels by the servomotors. Any torque differences can be compensated for within specified tolerances.

It may be advantageous to specify a higher coupling torque when the first actuator drive is actuated than when the second actuator drive is actuated. The first actuator drive is actuated by a synchronous drive of the first and second drive wheels. The friction element and the counter friction element are preloaded against each other by the spring force of the spring element, and in addition, the adjustment force of the first actuator drive acts in the opposite direction to the spring force. This results in a relatively high coupling torque. If, on the other hand, only the second drive wheel is rotated to adjust the air gap, only the spring force acts, so that a lower coupling torque is set. This makes it easier to adjust the air gap.

In the versions described above, the first actuator drive may preferably form a brake drive according to the function given above, and accordingly the second actuator drive may form an adjustment drive.

### DESCRIPTION OF THE DRAWINGS

Advantageous embodiments of the invention are explained in more detail below on the basis of the drawings. In detail:

FIG. 1 shows a braking device according to the invention in a schematic perspective view,

FIG. 2 shows a lateral view of the braking device according to FIG. 1,

FIG. 3 shows the positioning device according to the invention of the braking device according to FIG. 1, separately in a schematic perspective view,

FIG. 4 shows a Q-Q section through the braking device according to FIG. 1,

FIG. 5 shows the first actuator drive of the braking device according to FIG. 1, separately in a schematic perspective representation,

FIG. 6 shows an enlarged detail view of the actuator from FIG. 4,

FIGS. 7a-e show schematic representations of the steps in the execution of the method according to the invention.

### EMBODIMENTS OF THE INVENTION

In the different figures, the same parts are always provided with the same reference signs and are therefore usually only named or mentioned once.

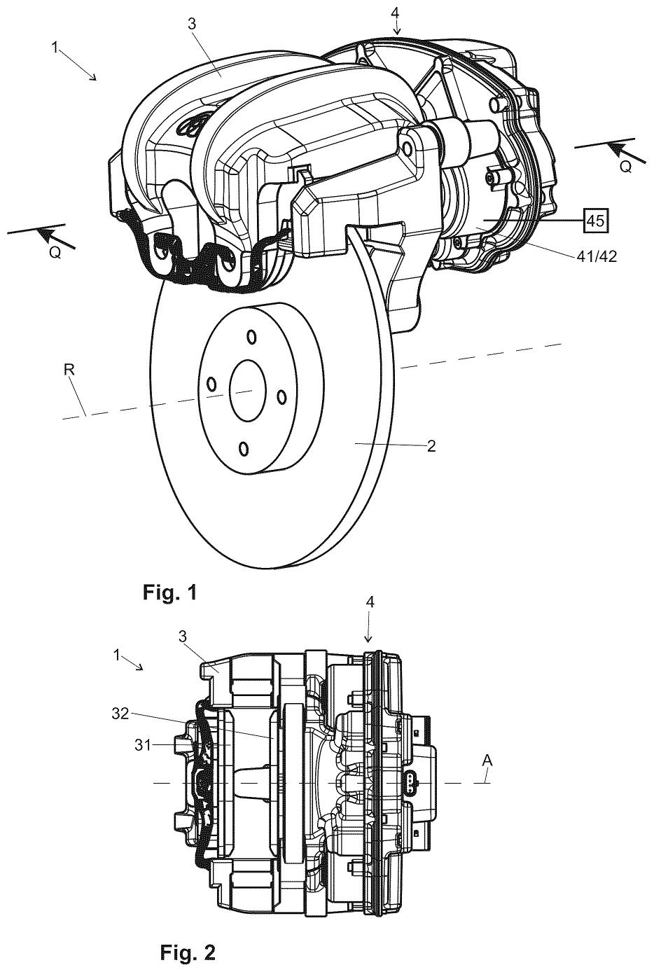

FIG. 1 shows a braking device according to the invention as a whole, which is in the form of a disc brake. This contains a brake disc 2, which forms a counter brake part in the sense of the invention and is connected to a vehicle wheel that is not shown here and that can be rotated around a wheel axis R. A brake caliper 3 encloses the two axial end faces of the brake disc 2.

The brake disc 2 is in the form here of an unventilated brake disc made of solid material. Alternatively, this can also be in the form of an internally ventilated brake disc.

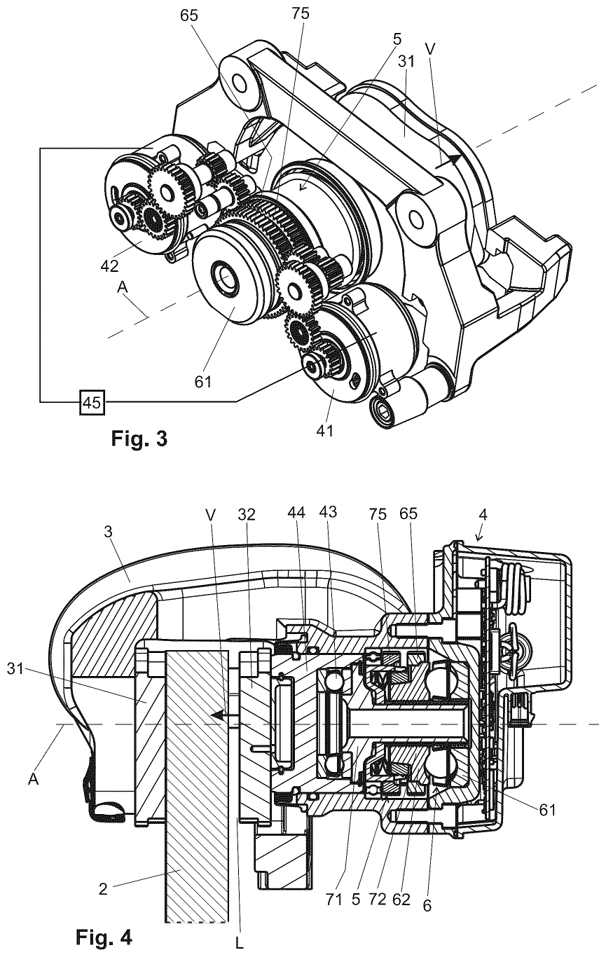

An electric brake actuator 4 according to the invention which is attached to the caliper 3 is shown in FIG. 3 in a separate, isolated schematic perspective view, and is explained in detail in FIGS. 4 to 6.

The brake actuator 4 contains an actuator 5 which extends axially in the direction of an axis A, which is parallel to the wheel axis R and indicates the adjustment direction V of the actuator 5.

As can be seen in the cross-sectional diagram of FIG. 4 along the axis A, the brake disc 2 is arranged axially between two brake pads 31 and 32. One brake pad 31 is firmly supported on the brake caliper 3 on the side facing away from the brake actuator 4. The other brake pad 32, which forms a brake part in the sense of the invention, is attached to the actuator 5 and can be adjusted by it in the axial adjustment direction V defined by the axis A to produce application of the brake on the brake disc 2, as indicated in FIG. 4 with the arrow.

In the unactivated state of the braking device 1, there is an axial air gap L between the brake disc 2 and the adjustable brake pad 32, which is shown schematically exaggeratedly wide in FIG. 4.

The structure of the actuator 5 is shown in FIG. 4 and in the enlarged section of it in FIG. 6.

The actuator 5 contains a first actuator drive 6, which has a ramp bearing, and a second actuator drive 7, which is thus serially coupled to it axially (with respect to axis A) and which has a spindle drive.

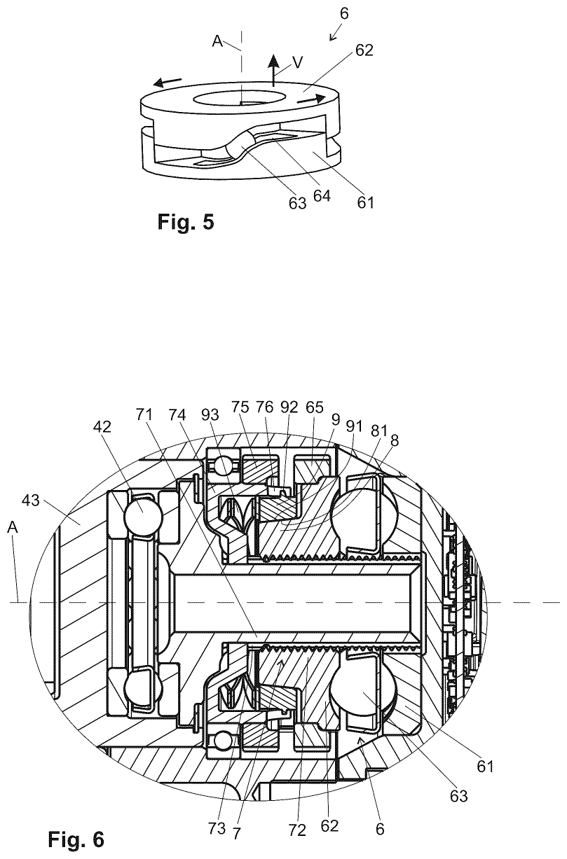

The first actuator drive 6, which is in the form of a ramp bearing in the example shown, contains an axially and torsionally supported cam disc 61 on the brake actuator 4 and a cam disc 62 on the output side. Balls 63 are arranged between the cam discs 61 and 62. As can be seen in the schematic separate view of FIG. 5, the cam discs 61 and 62 have axially opposite ramp-like tracks 64 lying obliquely to the axis A, between which balls 63 can be rolled. A rotation of the cam disc 62 on the output side, at the top in FIG. 5, relative to the fixed cam disc 61 on the drive side—as schematically indicated by the curved arrows—leads to a linear adjustment of the cam disc 62 on the output side in the adjustment direction V parallel to the axis A. As a result, the brake pad 32 can be brought into braking application as shown in FIG. 4 by operating the first actuator drive 6.

The cam disc 62 is connected to a coaxial gear wheel 65, which is in the form of a spur gear and forms a drive wheel in the sense of the invention.

The gear wheel 65 is in gear engagement with a first electric servomotor 41. This enables the rotating drive of the cam disc 62 and thus an actuation of the first actuator drive 6.

The second actuator drive 7, which is in the form of a spindle drive in the example shown, has a threaded spindle 71 on the output side, which engages in the internal thread of a spindle nut 72 on the drive side. This internal thread is formed in the output-side cam disc 62 of the first actuator drive 6, so that the functions of the output-side cam disk 62 and the drive-side spindle nut 72 are combined in one component.

The threaded spindle 71 is connected via a hub part 74 to a coaxial gear wheel 75, which is axially fixed in the brake actuator 4 and rotatably supported. The threaded spindle is coupled to the gear wheel 75 via drivers 73, which may, for example, have radially protruding protrusions or teeth that engage axially movably in axial slots of the hub part 74.

The gear wheel 75 can be in the form of a spur gear like the gear wheel 65 and is arranged co-axially adjacent to it. This gear wheel 75 is gear engaged with a second electric servomotor 42. This enables the rotary drive of the threaded spindle 71 and thus actuation of the second actuator drive 7.

The threaded spindle 71 is axially connected to a thrust piece 44, to which the displaceable brake pad 32 is attached, as can be seen in FIG. 4, by means of a thrust bearing 43, for example an axial roller bearing as shown. The thrust piece 44 can also be referred to as a piston.

The coupling device according to the invention has a friction element 8, which is oriented as a coaxial, conical attachment from the cam disc 62 to the second actuator drive 7. The conical attachment has a conical friction surface 81 arranged externally on an outer cone. The friction element 81 can preferably be formed in one piece with the cam disc 62/spindle nut 72.

The friction element 8 is coupled frictionally to a counter friction element 9 in the coupling engagement. The conical attachment is axially inserted into a corresponding conical opening of the counter friction element 9, which has a conical friction surface 91 arranged in an inner cone. In coupling engagement, the friction surface 81 and the counter friction surface 91 are frictionally engaged with each other, as can be clearly seen in FIG. 6.

The counter friction element 9 is coupled to the gear wheel 75 via drivers 92, which engage axially displaceably in corresponding slots 76 in the hub part 74 or the gear wheel 75.

A spring element 93 is arranged between the gear wheel 75 or the hub part 74 connected to it and the counter friction element 9. Due to its axially effective spring force, the counter friction element 9 is elastically clamped against the friction element 8. As a result, a defined coupling torque of the friction coupling according to the invention formed by the friction element 8 and the counter friction element 9 is produced.

The second embodiment shown in the same view as in FIG. 6 differs in the design and arrangement of the friction surface 81 and the counter friction surface 91, both of which are in the form of flat axial surfaces, as distinct from the conical surfaces of the first embodiment shown in FIGS. 4 and 6. The functionality is basically the same, and therefore the same reference signs are used.

To operate the braking device 1, the gear wheels 65 and 75 are rotated synchronously, so that the first actuator drive 6 performs a working stroke in the adjustment direction V, so that the brake pad 32 traverses the air gap L and comes into braking engagement with the brake disc 2. The synchronous drive of the gear wheels 65 and 75 can be achieved by synchronizing the drive speeds of the servomotors 41 and 42, or by driving only one of the servomotors 41 or 42, while the other servomotor 42 or 41 runs freely. In this case, the frictional coupling engagement between the friction element 8 and the counter friction element 9 ensures synchronous rotation of the gear wheels 65 and 75.

To adjust the width of the air gap L, the gear wheel 65 is fixed or blocked, for example by appropriate control of the first servomotor 41. The second servomotor 42 rotates the gear wheel 75 relative to the gear wheel 65, wherein the friction coupling slips continuously and smoothly. Accordingly, the second actuator drive 7 is adjusted evenly, which means that the width of the air gap L can also be continuously adjusted and adapted, for example to compensate for wear on the brake pad 32.

The fact that the friction element 8 and the counter friction element 9 are arranged wholly or at least partially within the gear wheels 65 and 75 makes it possible to achieve a particularly compact design.

The braking devices shown in FIGS. 1 to 7 are in the form of floating caliper brakes, also known as sliding caliper brakes. In this case, the brake pad 32 is pressed against the brake disc 2 by the thrust piece 44, and the brake pad 31 is pressed against the brake disc 2 by the brake caliper 3, which can be moved in the direction of the axis A. Alternatively, the solution according to the invention can also be used for a fixed caliper brake.

In the embodiments according to FIGS. 1 to 6, the first actuator drive 6 forms a brake drive or working drive in the sense of the method according to the invention, and the second actuator drive 7 accordingly forms an adjustment drive.

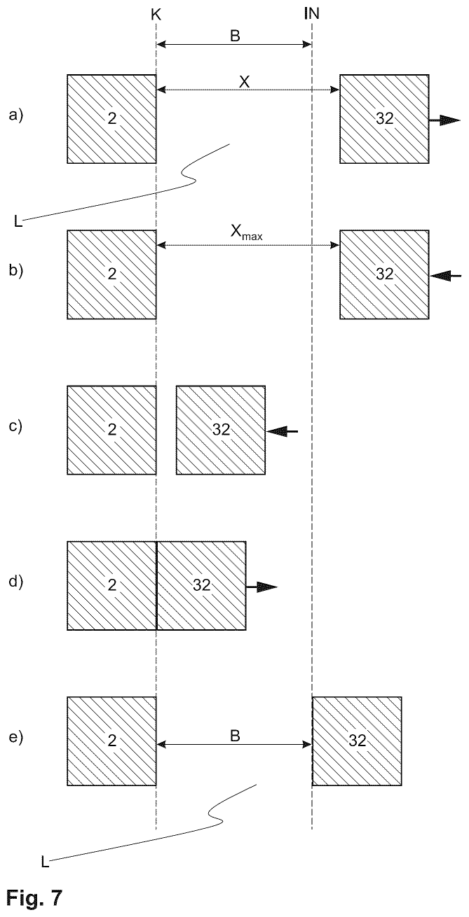

In FIG. 7 a) to e) the individual steps of a possible implementation of the method according to the invention for operating an electromechanical braking device are depicted schematically, based on a braking device 1.

In detail, the brake pad 32, which forms the brake part, and the brake disk 2, which forms the counter brake part, are shown. In between is the air gap L, the air gap width x of which measured in the adjustment direction is adjustable by means of the actuator drives 6 and 7.

The second actuator drive 7, the brake drive, has a constant specified adjustment distance when the brake is applied. This corresponds to the air gap width B defined according to the invention. The initial position IN is spaced apart from the friction surface of the brake disc 2 by this defined air gap width B.

FIG. 7a shows an initial situation in the released position of the braking device 1 in an unadjusted state, wherein the air gap width x is larger than the defined air gap width B, for example due to wear of the brake pad 32 and/or the brake disc 2. To clarify, the deviation from the initial position IN is drawn oversized.

From the situation shown in FIG. 7a, the brake pad 32 is reset by means of the second actuator drive 7, the adjustment drive, by adjusting it away from the brake disc 2, as indicated by the arrow pointing to the right. The first actuator drive 6, the brake drive, is in the resting position, in which it is reset to the maximum.

The reset represents a displacement-controlled adjustment in accordance with the fixed adjustment distance of the first actuator drive 6.

By resetting the brake pad 32 by means of the second actuator drive 7, the position shown in FIG. 7b is achieved. Because both actuator drives 6 and 7 are reset to the maximum extent, a maximum air gap width xmax is set.

From the position shown in FIG. 7b, by actuating the first actuator drive 6 the brake pad 32 is adjusted forwards towards the brake disc 2 by a specified adjustment distance B corresponding to the defined air gap width B, as indicated by the arrow pointing to the left.

This achieves the position shown in FIG. 7c, in which the brake pad 32 is spaced apart from the brake disc 2 due to the aforementioned wear.

Starting from this, the second actuator drive 7 is activated to move the brake pad 32 further forwards in the adjustment direction, as indicated by the arrow pointing to the left.

The adjustment by means of the second actuator drive 7 is continued until the brake pad 32 butts against the brake disc 2 in brake contact K, as shown in FIG. 7d. This position in brake contact K corresponds to application of the brake.

From brake contact K according to FIG. 7d, the brake pad 32 is reset away from the brake disc 2 by means of the first actuator drive 6 by an adjustment distance which corresponds to the defined air gap width B, as indicated by the arrow pointing to the right. Due to the fixed adjustment distance of the first actuator, this is again a displacement-controlled adjustment.

As a result, the brake pad 32 is positioned in the initial position IN, in which the air gap L has the optimal air gap width B.

During a subsequent braking operation, only the first actuator drive 6 is actuated, wherein an adjustment is made by the magnitude of the optimum air gap width B and an optimized brake application in brake contact is produced, which corresponds to the position according to FIG. 7d.

To control the actuator drives 6 and 7, their actuator motors 41 and 42 are connected to an electric control unit 45, which is schematically shown in FIGS. 1 and 3. This is designed to adjust the first actuator drive 6 by the amount of the defined air gap width B during a braking operation. In addition, the control unit 45 can detect the achievement of the brake contact shown in FIG. 7d, for example by the increase of the motor current of the servomotor 42 of the second actuator drive 7 when the brake pad 32 contacts the brake disc 2.

It is also conceivable and possible to carry out the method with a braking device which has only one actuator drive, which has a spindle drive similar to the second actuator drive 7. This then also takes over the presentation according to FIG. 7b and the reset according to FIG. 7d, and the production of the brake contact in a subsequent braking process. The brake pad 32 can then be moved forwards and reset by distance control of the servomotor by the control unit 45.

### LIST OF REFERENCE SIGNS

1 Braking device
2 Brake disk
3 Caliper
31, 32 Brake pad
4 Brake actuator
41, 42 Servomotor
43 Thrust bearing
44 Thrust piece
45 Control unit
5 Actuator
6 First actuator drive (brake drive)
61 Cam disk
62 Cam disk (integrated with spindle nut 72)
63 Ball
64 Track
65 Gear wheel
7 Second actuator drive (adjustment drive)
71 Threaded spindle
72 Spindle nut (integrated with cam disk 62)
73 Driver
74 Hub part
75 Gear wheel
76 Slit
8 Friction element
81 Friction surface
9 Counter friction element
91 Counter friction surface
92 Driver
93 Spring element
A Axis
R Wheel axis
V Adjustment direction
L Air gap
x Air gap width
B Defined air gap width
IN Initial position
K Brake contact

1-15. (canceled)

16. A method for operating an electromechanical braking device containing a brake part, a counter brake part, and an electromotive actuator, the method comprising:
moving the brake part, by the actuator, from a release position, in which an air gap is arranged between the brake part and the counter brake part, in an adjustment direction while overcoming the air gap into braking contact with the counter brake part, thereby applying the brake;
wherein, before applying the brake, the brake part is positioned by the actuator in an initial position in which a defined air gap width of the air gap between the brake part and the counter brake part is specified.

17. The method as claimed in claim 16, wherein a calibration routine is carried out to adjust the defined air gap width, comprising:
adjusting the brake part to a reference position; and
adjusting the brake part from the reference position to the initial position.

18. The method as claimed in claim 17, wherein the reference position is formed by the brake contact.

19. The method as claimed in claim 16, wherein a reference position is detected in brake contact and then the actuator is controlled to adjust the brake part from the reference position by a specified adjustment distance to the initial position.

20. The method as claimed in claim 16, wherein the current position of the brake part is detected.

21. The method as claimed in claim 16, wherein the actuator is position-controlled.

22. The method as claimed in claim 16, wherein the actuator is distance-controlled.

23. The method as claimed in claim 16, wherein the actuator contains an actuator drive and a spindle drive which is rotated by a servomotor.

24. The method as claimed in claim 16, wherein the actuator has a first actuator drive and a second actuator drive serially coupled thereto.

25. The method as claimed in claim 24, wherein the initial position is set by the one actuator drive and the braking application is produced by the other actuator drive.

26. An electromechanical braking device for a motor vehicle, comprising:
an actuator; and
a brake part that is connected to the actuator and can be adjusted by the actuator in an adjustment direction, along an axis, and can be brought into braking application with a counter brake part, and containing a control device for controlling the actuator;
wherein the actuator can be controlled by the control device for setting an initial position in which a defined air gap width of the air gap between the brake part and the counter brake part is specified.

27. The braking device as claimed in claim 26, wherein the control device is connected to at least one sensor device which is designed to detect the position of the actuator and/or to detect the adjustment distance of the actuator.

28. The braking device as claimed in claim 26, wherein the control device is connected to at least one sensor device designed to detect a brake contact between the brake part and the counter brake part.

29. The braking device as claimed in claim 26, wherein the control device is designed for adjusting the actuator to a specified position and/or for adjusting the actuator by a specified adjustment distance.

30. The braking device as claimed in claim 26, wherein the control device has a control input for entering an initial value, and the control device is designed for adjusting the actuator to an initial position corresponding to the entered initial value.
